(19) United States
(12) Patent Application Publication
(10) Pub. No.: US 2025/0385042 A1
(43) Pub. Date: Dec. 18, 2025

(54) CASTING TYPE POWER INDUCTOR AND PREPARATION METHOD THEREFOR

(71) Applicant: HENGDIAN GROUP DMEGC MAGNETICS CO., LTD, Jinhua (CN)

(72) Inventors: Yangdong Yu, Jinhua (CN); Leijie Wang, Jinhua (CN); Quan Zhu, Jinhua (CN); Jianyu Chen, Jinhua (CN)

(73) Assignee: HENGDIAN GROUP DMEGC MAGNETICS CO., LTD, Jinhua, OT (CN)

(21) Appl. No.: 18/835,926

(22) PCT Filed: Feb. 3, 2023
(86) PCT No.: PCT/CN2023/074387

§ 371 Date: Apr. 2, 2025

(30) Foreign Application Priority Data
Jun. 24, 2022 (CN) 202210728699.8

(51) Int. Cl. H01F 41/02; H01F 1/26; H01F 27/255; H01F 27/28; H01F 27/29; H01F 37/00; H01F 41/00; H01F 41/08; H01F 41/10

(52) U.S. Cl. CPC H01F 41/0246; H01F 1/26; H01F 27/255; H01F 27/2828; H01F 27/292; H01F 37/00; H01F 41/005; H01F 41/08; H01F 41/10

(57) ABSTRACT

A casting type power inductor includes a base, a hollow coil, and a casting. The base includes a flange and a central column. The central column is fixedly arranged at the center of the flange. The hollow coil is tightly wound on the central column. The casting is used for wrapping the base and the hollow coil. The preparation method for the casting type power inductor includes blank preparation, coil winding, combined body arrangement, slurry casting, curing treatment, and post-treatment that are sequentially performed. According to the casting type power inductor, pressureless forming can be implemented by casting a magnetic slurry, so that a short circuit, an open circuit, or deviation to the edge of the inductor, of the coil caused by excessive pressure is avoided.

### TECHNICAL FIELD

Examples of the present application relate to the technical field of electronic components, for example, a power inductor, and especially relate to a pouring power inductor and a preparation method therefor.

### BACKGROUND

With the rapid development of science and technology, the requirements for the performance and reliability of electronic products are becoming increasingly stringent. Inductor, as one of three passive components of electronic circuits, plays a role in filtering, oscillation, denoising, stabilizing current and suppressing electromagnetic interference in the circuit. Technology is changing rapidly nowadays, and the inductor is required to withstand increasingly high current and frequency. The conventional dry pressing integrally-molded inductor requires a large molding pressure, which can easily lead to large deformation of the internal coil of the inductor or destruction of the insulating paint on the surface of the copper wire, resulting in open circuit and short circuit during the pressing process. In addition, the dry pressing molding process has high demand in molding equipment and molds, and because the production efficiency of the product is limited by the tonnages of the press and the mold design, the production cost of the inductor is stubbornly high.

In view of the above, the magnetic slurry pouring molding is a focus of research, but this process is to mix a magnetic material with a binder to form a viscous substance with a high viscosity, resulting in a lower solid content of the magnetic powder compared with compression molding, so that the inductance value is low.

CN213752214U discloses a pouring inductor. The pouring inductor comprises a box and a conductor coil, the box is molded by pressing a magnetic powder, the conductor coil is arranged in the box and terminals of the leading wire of the conductor coil extend from the box, a magnetic slurry is poured into the box, and the magnetic slurry is leveled with the open edge of the box, and the box, the conductor coil and the magnetic slurry are poured and molded as a whole. The pouring inductor provided by this patent is molded by pouring without pressing the coil, effectively avoiding the deformation of the coil and the magnetic leakage. However, the utility model patent adopts the process of first pressing a magnetic powder to a box, and then arranging a coil in the box individually and pouring; the process is complicated, and the production efficiency is low. For producing miniature inductors, the box wall is thin and easy to break during assembly process, which is not suitable for mass production of small-size inductors.

CN112397295A discloses a method for manufacturing an integral molding inductor, and the manufacturing method comprises: firstly, pre-pressing a soft magnetic alloy material into a flat plate body and a T-shaped body, then precisely winding an enameled wire on a columnar protrusion of the T-shaped body, then placing the T-shaped body with the enameled wire into a hot pressing mold in a “⊥” shape arrangement, placing the prepared flat plate body above the T-shaped body, and performing hot pressing molding to obtain an integral molding inductor body; finally, spray-coating the integral molding inductor body and electroplating electrodes to obtain an integral molding inductor. The manufacturing method provided by this patent only solves the problems that in the production of integrated forming inductors, the unevenness of the prepared powder particles causes a large deviation in the amount of powder filled into each cavity of the mold in the molding stage, resulting in a large deviation in the size, weight and performance of the pressed inductor body, and the defective product already contains enameled wires and other components, and the powder is difficult to recycle. This manufacturing method is still impossible to avoid open circuit and short circuit caused by the large deformation of the internal coil of the inductor during the molding process or the damage of the insulating paint on the surface of the enameled wire.

In summary, it is urgent to provide an inductor and a preparation method therefor in this field to solve the technical problems in the prior art such as high molding pressure, high requirements for molding equipment, and short circuit and open circuit of the damaged copper wire caused by excessively high molding pressure.

### SUMMARY

The following is a summary of the subject described in detail herein. This summary is not intended to limit the protection scope of the claims.

An example of the present application provides a pouring power inductor and a preparation method therefor. The pouring power inductor realizes pressureless molding by pouring a magnetic slurry to prevent the coil from short circuit, open circuit or shift to the edge of the inductor due to high pressure; the reliability of the inductor and the yield of the product are effectively improved.

In a first aspect, an example of the present application provides a pouring power inductor, and the pouring power inductor comprises a T-shaped base, a coil and a pouring body;
the base comprises a lower portion and a center post;
the center post is fixed at the center of the lower portion;
the coil is tightly wound on the center post;
the pouring body is used to enclose the base and the coil.

The pouring power inductor provided by the present application solves the technical problems in the prior art such as high molding pressure, high requirements for molding equipment, and short circuit and open circuit of the damaged copper wire caused by excessively high molding pressure.

Preferably, one side of the lower portion is provided with wire grooves.

Preferably, two terminals of the coil are arranged on the bottom of the lower portion through the wire grooves.

In a second aspect, an example of the present application provides a method for preparing the pouring power inductor according to the first aspect, and the preparation method comprises the following steps:
(1) body preparation: putting a prepared powder into a T-shaped mold with a preset size and performing hot press molding, and then baking the same to obtain a T-shaped base;
(2) coil winding: winding an enameled wire onto a center post of the T-shaped base obtained in step (1), and bending two terminals and fitting the same to the bottom of a lower portion of the T-shaped base to obtain a combined component;
(3) combined component arrangement: arranging and sticking the combined components obtained in step (2) onto a thermosensitive adhesive film in an n×m array at equal spacing;
(4) slurry pouring: installing a pouring mold above the thermosensitive adhesive film, and injecting a magnetic slurry to obtain a second combined component;
(5) curing treatment: subjecting the second combined component obtained in step (4) to curing treatment, demolding and grinding in turn to obtain an inductor body; and
(6) post-treatment: subjecting the inductor body obtained in step (5) to cutting, spray coating and plating in turn to obtain the pouring power inductor.

The method for preparing a pouring power inductor provided by the present application adopts one-step pressureless molding, which solves the technical problems in the prior art such as high molding pressure, high requirements for molding equipment, and short circuit and open circuit of the damaged copper wire caused by excessively high molding pressure.

Preferably, a method for preparing the prepared powder in step (1) comprises:
(1.1) mixing a main powder and an auxiliary powder to obtain a composite soft magnetic alloy powder; and
(1.2) mixing a binder, a curing agent, acetone and the composite soft magnetic alloy powder obtained in step (1.1) to obtain the prepared powder.

Preferably, the main powder in step (1.1) comprises any one or a combination of at least two of a FeSiAl powder, a FeSi powder or a FeNi powder, and typical but non-limited combinations comprise a combination of a FeSiAl powder, a FeSi powder and a FeNi powder, a combination of a FeSiAl powder and a FeSi powder, a combination of a FeSiAl powder and a FeNi powder, or a combination of a FeSi powder and a FeNi powder.

Preferably, the main powder in step (1.1) has the D50 of 20-40 μm, and for example, it can be 20 μm, 25 μm, 30 μm, 35 μm or 40 μm; however, the D50 is not limited to the listed values, and other unlisted values within this value range are also applicable.

Preferably, the auxiliary powder in step (1.1) comprises any one or a combination of at least two of a FeSiAl powder, a FeSi powder or a FeNi powder, and typical but non-limited combinations comprise a combination of a FeSiAl powder, a FeSi powder and a FeNi powder, a combination of a FeSiAl powder and a FeSi powder, a combination of a FeSiAl powder and a FeNi powder, or a combination of a FeSi powder and a FeNi powder.

Preferably, the auxiliary powder in step (1.1) has the D50 of 2-10 μm, and for example, it can be 2 μm, 3 μm, 4 μm, 5 μm, 6 μm, 7 μm, 8 μm, 9 μm or 10 μm; however, the D50 is not limited to the listed values, and other unlisted values within this value range are also applicable.

The composition of the main powder and auxiliary powder in the composite soft magnetic alloy powder in step (1.1) of the present application can be identical, and the selection of materials is determined by the specific application requirements. The FeSiAl material has high hardness, high saturation magnetic induction intensity Bs, high magnetic permeability, high resistivity and low cost; its disadvantages are mutable magnetic performance that is sensitive to the fluctuation of the composition, large brittleness, and poor processability. Compared with FeSiAl, the FeSi material has higher saturation magnetic induction intensity and higher energy storage capacity, and is suitable for a high-current working condition. Compared with iron-silicon-aluminum, FeNi has better DC superposition characteristic, and the material cost is higher because the powder contains about 50% of nickel.

Preferably, the hot press molding in step (1) is performed at 160-240° C., and for example, it can be 160° C., 170° C., 180° C., 190° C., 200° C., 210° C., 220° C., 230° C. or 240° C.; however, the temperature is not limited to the listed values, and other unlisted values within this value range are also applicable.

Preferably, the hot press molding in step (1) is performed at 300-600 MPa, and for example, it can be 300 MPa, 350 MPa, 400 MPa, 450 MPa, 500 MPa, 550 MPa or 600 MPa; however, the pressure is not limited to the listed values, and other unlisted values within this value range are also applicable.

Preferably, the baking in step (1) is performed at 180-260° C., and for example, it can be 180° C., 190° C., 200° C., 210° C., 220° C., 230° C., 240° C., 250° C. or 260° C.; however, the temperature is not limited to the listed values, and other unlisted values within this value range are also applicable.

An object of the hot pressing molding in the present application is to ensure that the T-shaped body can obtain better strength, and to prevent the center post on the T-shaped base from fracturing during the process of coil winding.

Preferably, the spacing of the combined components in step (3) is 0.5-2 mm, and for example, it can be 0.5 mm, 0.8 mm, 1 mm, 1.2 mm, 1.4 mm, 1.6 mm, 1.8 mm or 2 mm; however, the spacing is not limited to the listed values, and other unlisted values within this value range are also applicable.

Reserving the spacing among the combinations is mainly to allow the pouring body to closing completely, effectively ensuring the adhesion between the pouring body and the combined components.

Preferably, a thermosensitive adhesive in the thermosensitive adhesive film of step (3) has an adhesion of 2000-3000 gf/25 mm, and for example, it can be 2000 gf/25 mm, 2200 gf/25 mm, 2400 gf/25 mm, 2600 gf/25 mm, 2800 gf/25 mm, or 3000 gf/25 mm; however, the adhesion is not limited to the listed values, and other unlisted values within this value range are also applicable.

The adhesion range of the thermosensitive adhesive is limited in the present application to ensure that the coil and the T-shaped base can be tightly stuck by the thermosensitive adhesive.

Preferably, the magnetic slurry in step (4) has a viscosity of 15000-25000 mpa·s, and for example, it can be 15000 mpa·s, 17000 mpa·s, 19000 mpa·s, 21000 mpa·s, 23000 mpa·s or 25000 mpa·s; however, the viscosity is not limited to the listed values, and other unlisted values within this value range are also applicable.

The magnetic slurry in step (4) of the present application has a magnetic permeability of 25-35 at a frequency of 100 kHz.

Preferably, raw materials of the magnetic slurry in step (4) comprises (in parts by weight): 100 parts of a composite soft magnetic alloy material, and 2-8 parts of an epoxy resin, and for example, it can be 2 parts, 3 parts, 4 parts, 5 parts, 6 parts, 7 parts or 8 parts, however, the epoxy resin is not limited to the listed values, and other unlisted values within this value range are also applicable; 0.5-2.5 parts of a curing agent, and for example, it can be 0.5 parts, 0.8 parts, 1 part, 1.4 parts, 1.8 parts, 2.2 parts or 2.5 parts, however, the curing agent is not limited to the listed values, and other unlisted values within this value range are also applicable; and 2-6 parts of an organic solvent, and for example, it can be 2 parts, 3 parts, 4 parts, 5 parts or 6 parts, however, the organic solvent is not limited to the listed values, and other unlisted values within this value range are also applicable.

In the present application, the addition amount of the epoxy resin is to ensure a certain bonding strength between the pouring body and the combined component of the coil and T-shaped base, and to ensure that the cured pouring body has a certain magnetic permeability at the same time. When the addition amount of the epoxy resin is small, the bonding strength between the pouring body and the combined component is reduced, resulting in falling apart. When the addition amount of the epoxy resin is large, the magnetic permeability of the pouring body will be reduced, and the inductance value of the inductor will not meet the technical requirements.

Preferably, the curing agent comprises any one or a combination of at least two of ethylenediamine, diethylenetriamine, diethyltoluenediamine or dicyandiamide, and typical but non-limited combinations comprise a combination of ethylenediamine and diethylenetriamine, or a combination of diethyltoluenediamine and dicyandiamide.

Preferably, the organic solvent comprises any one or a combination of at least two of ethyl acetate, n-propanol, isopropanol or ethanol, and typical but non-limited combinations comprise a combination of n-propanol and isopropanol, a combination of n-propanol and ethanol, or a combination of ethyl acetate and ethanol.

Preferably, a method for preparing the magnetic slurry in step (4) comprises:
(4.1) mixing an epoxy resin with an organic solvent and stirring for 1-3 h to obtain an organic mixture;
(4.2) adding a composite soft magnetic alloy material to the organic mixture obtained in step (4.1), and stirring for 4-12 h to obtain a semi-finished soft magnetic alloy powder slurry; and
(4.3) mixing and stirring a curing agent and the semi-finished soft magnetic alloy powder slurry obtain in step (4.2) for 20-40 min, and then performing vacuum degassing to obtain the magnetic slurry.

Preferably, the composite soft magnetic alloy material in step (4.2) is a mixture of a first powder, a second powder and a third powder.

Preferably, the first powder comprises any one or a combination of at least two of a FeSiAl powder, a FeSi powder, a FeNi powder or an amorphous powder;
preferably, the first powder has the D50 of 100-150 μm, and for example, it can be 100 μm, 110 μm, 120 μm, 130 μm, 140 μm or 150 μm; however, the D50 is not limited to the listed values, and other unlisted values within this value range are also applicable.

Preferably, the second powder comprises any one or a combination of at least two of a FeSiAl powder, a FeSi powder, a FeNi powder or an amorphous powder;
preferably, the second powder has the D50 of 20-50 μm, and for example, it can be 20 μm, 25 μm, 30 μm, 35 μm, 40 μm, 45 μm or 50 μm; however, the D50 is not limited to the listed values, and other unlisted values within this value range are also applicable.

Preferably, the third powder comprises any one or a combination of at least two of a FeSiAl powder, a FeSi powder, FeNi or an amorphous powder;
preferably, the third powder has the D50 of 4-10 μm, and for example, it can be 4 μm, 5 μm, 6 μm, 7 μm, 8 μm, 9 μm or 10 μm; however, the D50 is not limited to the listed values, and other unlisted values within this value range are also applicable.

Preferably, the first powder, the second powder and the third powder have a mass ratio of 6:(1-3):(1-3), and for example, it can be 6:1:1, 6:1:3, 6:3:1, 6:2:3, 6:3:3 or 6:3:2; however, the mass ratio is not limited to the listed values, and other unlisted values within this value range are also applicable.

Preferably, the amorphous powder comprises FeSiBCr.

The composite soft magnetic alloy material in the present application is obtained by mixing the first powder (coarse powder), the second powder (medium powder) and the third powder (fine powder) with completely different particle sizes. Each of the coarse, medium and fine powders are required to be annealed at high temperature before mixing to eliminate internal stress, which is conducive to reducing magnetic hysteresis loss.

The particle size of the coarse powder in the composite soft magnetic alloy material provided by the present application is much larger than that of the powder used in the conventional molding process. The coarse, medium and fine powders are mixed and matched, and the medium and fine powders are fully filled into the gaps among coarse powder particles, improving the filling density of the slurry, achieving high magnetic permeability of the pouring body and solving the problem of low magnetic permeability in a pressureless state. In addition, an epoxy resin content of the slurry used in the pouring body is high, which can not only improve the strength of the product, but also better insulate the soft magnetic alloy powder, improve resistivity and reduce the eddy current loss.

Preferably, a height of the pouring mold in step (4) is 0.4-1.5 mm more than a height of the inductor, and for example, the height difference can be 0.4 mm, 0.5 mm, 0.6 mm, 0.7 mm, 0.8 mm, 0.9 mm, 1 mm, 1.2 mm, 1.4 mm or 1.5 mm; however, the height difference is not limited to the listed values, and other unlisted values within this value range are also applicable; preferably, the height difference is 0.6-1.2 mm.

In order to reserve the required amount of preset for the shrinkage of the slurry and the grinding of the cured pouring body, the mold height is required to be higher than the inductor height in the pouring process in the present application.

Preferably, the curing in step (5) comprises a first stage curing, a second stage curing and a third stage curing which are performed sequentially.

The curing described in the present application is a grading curing process. First of all, the magnetic slurry is cured at low temperature for a long time, and then the temperature is gradually increased, and the purpose is to ensure that the pouring body is dense in the curing process of epoxy resin and to avoid pore formation. Because the curing speed of the thermosetting epoxy resin is accelerated in the high temperature curing and the curing is an exothermic reaction, the curing speed can be promoted in a short time, the “ebullition” phenomenon is likely to occur, and the pores remain in the cured pouring body, decreasing the magnetic permeability and strength of the pouring body.

Preferably, the first stage curing is performed at 80-100° C., and for example, it can be 80° C., 84° C., 88° C., 92° C., 96° C. or 100° C.; however, the temperature is not limited to the listed values, and other unlisted values within this value range are also applicable.

Preferably, the first stage curing has a temperature-holding period of 2-4 h, and for example, it can be 2 h, 2.2 h, 2.4 h, 2.6 h, 2.8 h, 3 h, 3.2 h, 3.4 h, 3.6 h, 3.8 h or 4 h; however, the temperature-holding period is not limited to the listed values, and other unlisted values within this value range are also applicable.

Preferably, the second stage curing is performed at 120-140° C., and for example, it can be 120° C., 124° C., 128° C., 132° C., 136° C. or 140° C.; however, the temperature is not limited to the listed values, and other unlisted values within this value range are also applicable.

Preferably, the second stage curing has a temperature-holding period of 0.5-2 h, and for example, it can be 0.5 h, 0.8 h, 1 h, 1.2 h, 1.4 h, 1.6 h, 1.8 h or 2 h; however, the temperature-holding period is not limited to the listed values, and other unlisted values within this value range are also applicable.

Preferably, the third stage curing is performed at 150-200° C., and for example may be 150° C., 155° C., 160° C., 165° C., 170° C., 175° C., 180° C., 185° C., 190° C., 195° C. or 200° C.; however, the temperature is not limited to the listed values, and other unlisted values within this value range are also applicable.

Preferably, the third stage curing has a temperature-holding period of 1-3 h, and for example, it can be 1 h, 1.2 h, 1.4 h, 1.6 h, 1.8 h, 2 h, 2.2 h, 2.4 h, 2.6 h, 2.8 h, or 3 h; however, the temperature-holding period is not limited to the listed values, and other unlisted values within this value range are also applicable.

Preferably, after the spray coating, step (6) also comprises baking the sprayed material.

The grinding in step (5) of the present application can not only accurately control the height of the inductor, but also ensure that the surface of the pouring body is flat.

The cutting in step (6) of the present application is performed by a dicing machine or wire cutting. Firstly, the ground pouring body in step (5) is stuck with a UV adhesive film on the surface, and then placed on a work table with its UV adhesive film surface, and the UV adhesive film and the ground inductor body are fixed by a vacuum suction cup on the work table, and the ground inductor body is divide into n×m of inductor bodies by setting a starting mark and a moving distance of the work table; the moving distance of the work table is determined by a length and width of the inductor product.

As a preferred technical solution of the present application, the method for preparing the pouring power inductor provided in the second aspect of the present application comprises the following steps:
(1) body preparation: putting a prepared powder into a T-shaped mold with a preset size and performing hot press molding, and then baking the same at 180-260° C. to obtain a T-shaped base; the hot pressing molding is performed at 160-240° C. with a pressure of 300-600 MPa;
(1.1) mixing a main powder and an auxiliary powder to obtain a composite soft magnetic alloy powder; the D50 of the main powder is 20-40 μm, and the D50 of the auxiliary powder is 2-10 μm;
(1.2) mixing a binder, a curing agent, acetone and the composite soft magnetic alloy powder obtained in step (1.1) to obtain the prepared powder;
(2) coil winding: winding an enameled wire onto a center post of the T-shaped base obtained in step (1), and bending two terminals and fitting the same to the bottom of a lower portion of the T-shaped base to obtain a combined component;
(3) combined component arrangement: arranging and sticking the combined components obtained in step (2) onto a thermosensitive adhesive film which has an adhesion of 2000-3000 gf/25 mm in an n×m array at equal spacing; the spacing of the combined components is 0.5-2 mm;
(4) slurry pouring: installing a pouring mold above the thermosensitive adhesive film, and injecting a magnetic slurry with a viscosity of 15000-25000 mpa·s to obtain a second combined component; a height of the pouring mold is 0.4-1.5 mm more than a height of the inductor;
(4.1) mixing an epoxy resin with an organic solvent and stirring for 1-3 h to obtain an organic mixture;
(4.2) adding a composite soft magnetic alloy material into the organic mixture obtained in step (4.1), and stirring for 4-12 h to obtain a semi-finished soft magnetic alloy powder slurry; the composite soft magnetic alloy material is a mixture of a first powder, a second powder and a third powder; the D50 of the first powder is 100-150 μm, the D50 of the second powder is 20-50 μm, and the D50 of the third powder is 4-10 μm;
(4.3) mixing and stirring a curing agent and the semi-finished soft magnetic alloy powder slurry obtained in step (4.2) for 20-40 min, and then performing vacuum degassing to obtain the magnetic slurry;
(5) curing treatment: subjecting the second combined component obtained in step (4) to curing treatment, demolding and grinding in turn to obtain an inductor body; the curing treatment comprises a first stage curing, a second stage curing and a third stage curing which are performed sequentially; the first stage curing is performed at 80-100° C. and held for 2-4 h; the second stage curing is performed at 120-140° C. and held for 0.5-2 h; the third stage curing is performed at 150-200° C. and held for 1-3 h; and
(6) post-treatment: subjecting the inductor body obtained in step (5) to cutting, spray coating and plating in turn to obtain the pouring power inductor.

The value ranges in the present application comprise not only the above listed point values, but also any unlisted point values within the value ranges, and for reasons of space and brevity, the specific point values comprised in the ranges will not be listed exhaustively in the present application.

Compared with the related art, the examples of the present application have the following beneficial effects.

The pouring power inductor provided in the examples of the present application realizes pressureless molding by pouring a magnetic slurry to prevent the coil from short circuit, open circuit or shift to the edge of the inductor due to high pressure; the reliability of the inductor and the yield of the product are effectively improved.

After reading and understanding the drawings and detailed descriptions, other aspects can be understood.

### BRIEF DESCRIPTION OF DRAWINGS

Accompanying drawings are used to provide a further understanding of the technical solutions herein and form part of the specification. The accompanying drawings are used in conjunction with examples of the present application to explain the technical solutions herein, and do not limit the technical solutions herein.

FIG. 1 is a structural schematic diagram of a pouring power inductor provided in Example 1 of the present application;

FIG. 2 is a side section view of a pouring power inductor provided in Example 1 of the present application;

FIG. 3 is a structural schematic diagram of an inductor green body provided in Example 1 of the present application.

Reference list: 1—T-shaped base, 2—coil, 3—pouring body, 4—center post, 13—wire groove.

### DETAILED DESCRIPTION

The technical solutions of the present application will be further described below by embodiments. Those skilled in the art should understand that the examples are only used for a better understanding of the present application but should not be regarded as a specific limitation of the present application.

### Example 1

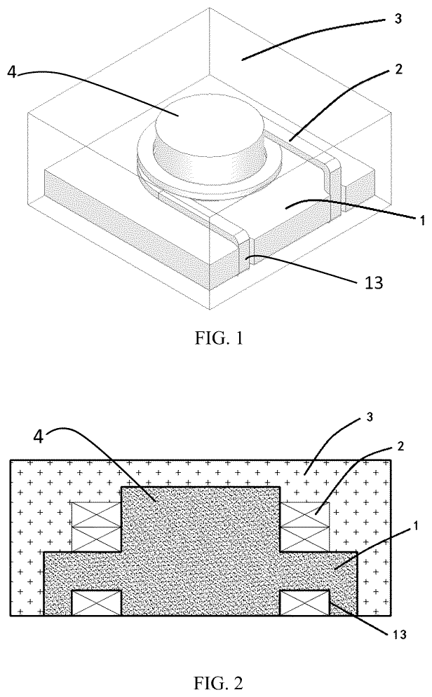

This example provides a pouring power inductor as shown in FIG. 1, and the pouring power inductor comprises a T-shaped base 1, a coil 2 and a pouring body 3;
the T-shaped base 1 comprises a lower portion and a center post 4; the center post 4 is fixed at the center of the lower portion; the coil 2 is tightly wound onto the center post 4; the pouring body 3 is used to enclose the T-shaped base 1 and the coil 2.

One side of the lower portion is provided with wire grooves 13; two terminals of the coil 2 are arranged on the bottom of the lower portion through the wire grooves 12.

A side section view of the pouring power inductor is shown in FIG. 2.

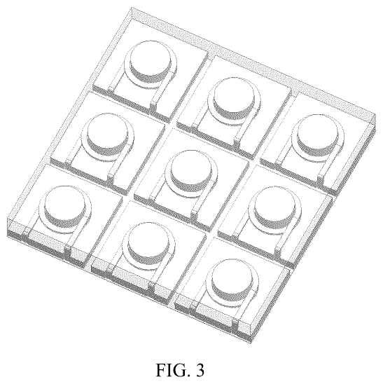

A method for preparing the pouring power inductor comprises the following steps:
(1) body preparation: a prepared powder was put into a T-shaped mold with a preset size and subjected to hot press molding, and then baked at 220° C. to obtain a T-shaped base; the hot pressing molding was performed at 180° C. with a pressure of 450 MPa;
(1.1) a main powder and an auxiliary powder were mixed to obtain a composite soft magnetic alloy powder; the D50 of the main powder was 39.84 μm, and the D50 of the auxiliary powder was 9.58 μm;
(1.2) a binder, a curing agent, acetone and the composite soft magnetic alloy powder obtained in step (1.1) were mixed to obtain the prepared powder;
(2) coil winding: an enameled wire was wound onto a center post of the T-shaped base obtained in step (1), and two terminals were bended and fitted to the bottom of a lower portion of the T-shaped base to obtain a combined component;
(3) combined component arrangement: the combined components obtained in step (2) were stuck onto a thermosensitive adhesive film with an adhesion of 2000-3000 gf/25 mm and arranged as an n×m array at equal spacing; the spacing of the combined components was 2 mm;
(4) slurry pouring: a pouring mold was installed above the thermosensitive adhesive film, and a magnetic slurry with a viscosity of 20000 mpa·s was injected to obtain a second combined component; wherein a height of the pouring mold was 1.2 mm more than a height of the inductor; raw materials of the magnetic slurry comprised (in parts by weight): 100 parts of a composite soft magnetic alloy material, 4 parts of an epoxy resin, 1.12 parts of ethylenediamine and 3.60 parts of ethyl acetate;
(4.1) an epoxy resin was mixed with ethyl acetate, stirred and mixed for 2 h to obtain an organic mixture;
(4.2) a composite soft magnetic alloy material was added to the organic mixture obtained in step (4.1), and stirred for 10 h to obtain a semi-finished soft magnetic alloy powder slurry; the composite soft magnetic alloy material was a mixture of a first powder, a second powder and a third powder; the D50 of the first powder was 146.8 μm, the D50 of the second powder was 49.6 μm, and the D50 of the third powder was 8.9 μm; a mass ratio of the first powder, the second powder and the third powder was 6:1:3;
(4.3) ethylenediamine and the semi-finished soft magnetic alloy powder slurry obtained in step (4.2) were mixed and stirred for 30 min, and then vacuum degassing was performed to obtain the magnetic slurry;
(5) curing treatment: the second combined component obtained in step (4) was cured, demolded and ground in turn to obtain an inductor body as shown in FIG. 3; the curing treatment comprised a first stage curing, a second stage curing and a third stage curing which were performed sequentially; the first stage curing was performed at 80° C. and held for 4 h; the second stage curing was performed at 125° C. and held for 1 h; the third stage curing was performed at 180° C. and held for 1 h; and
(6) post-treatment: the inductor body obtained in step (5) was cut, spray-coated and plated in turn to obtain the pouring power inductor.

A size of the pouring power inductor prepared in this example is 2.5×2.0×1.0 mm.

The magnetic permeability of the magnetic slurry obtained in step (4) of this example is tested to be 32.8 at a frequency f of 1 MHz.

### Example 2

This example provides a pouring power inductor, and the pouring power inductor is the same as in Example.

A method for preparing the pouring power inductor differs from Example 1 only in that: in this example, for preparing the magnetic slurry in step (4), weight proportions of raw materials were changed to 100 parts of a composite soft magnetic alloy material, 2.4 parts of an epoxy resin, 0.67 parts of ethylenediamine, and 2.8 parts of ethyl acetate. The magnetic permeability of the magnetic slurry is tested to be 34.87 at a frequency f of 1 MHz.

### Example 3

This example provides a pouring power inductor, and the pouring power inductor is the same as in Example.

A method for preparing the pouring power inductor differs from Example 1 only in that: in this example, for preparing the magnetic slurry in step (4), weight proportions of raw materials were changed to 100 parts of a composite soft magnetic alloy material, 6.0 parts of an epoxy resin, 1.68 parts of ethylenediamine, and 4.6 parts of ethyl acetate. The magnetic permeability of the magnetic slurry is tested to be 31.2 at a frequency f of 1 MHz.

In the preparation method provided in this example, the temperature of the first stage curing in the curing treatment of step (5) was also changed to 100° C., and the temperature-holding period changed to 2 h; the temperature of the second stage curing was changed to 140° C., and the temperature-holding period was 1 h; the temperature of the third stage curing was changed to 200° C., and the temperature-holding period was 1 h.

### Example 4

This example provides a pouring power inductor, and the pouring power inductor is the same as in Example.

A method for preparing the pouring power inductor differs from Example 1 only in that: in this example, the D50 of the first powder in step (4.2) was changed to 108.34 μm, the D50 of the second powder was changed to 28.86 μm, and the D50 of the third powder was changed to 4.2 μm; the mass ratio of the first powder, the second powder and the third powder was 6:2:2.

The magnetic permeability of the magnetic slurry obtained in step (4) of this example is tested to be 28.84 at a frequency f of 1 MHz.

### Example 5

This example provides a pouring power inductor, and the pouring power inductor is the same as in Example.

A method for preparing the pouring power inductor differs from Example 1 only in that: in this example, the mass ratio of the first powder, the second powder and the third powder was changed to 6:3:1.

The magnetic permeability of the magnetic slurry obtained in step (4) of this example is tested to be 30.82 at a frequency f of 1 MHz.

### Example 6

This example provides a pouring power inductor, and the pouring power inductor is the same as in Example.

A method for preparing the pouring power inductor differs from Example 1 only in that: in this example, the D50 of the first powder in step (4.2) was changed to 162.83 μm, the D50 of the second powder was changed to 54.69 μm, and the D50 of the third powder was changed to 10.84 μm.

The magnetic permeability of the magnetic slurry obtained in step (4) of this example is tested to be 38.54 at a frequency f of 1 MHz.

### Example 7

This example provides a pouring power inductor, and the pouring power inductor is the same as in Example.

A method for preparing the pouring power inductor differs from Example 1 only in that: in this example, for preparing the magnetic slurry in step (4), weight proportions of raw materials were changed to 100 parts of a composite soft magnetic alloy material, 1.80 parts of an epoxy resin, 0.5 parts of ethylenediamine, and 6.5 parts of ethyl acetate. The magnetic permeability of the magnetic slurry is tested to be 34.46 at a frequency f of 1 MHZ.

### Example 8

This example provides a pouring power inductor, and the pouring power inductor is the same as in Example.

A method for preparing the pouring power inductor differs from Example 1 only in that: in this example, for preparing the magnetic slurry in step (4), weight proportions of raw materials were changed to 100 parts of a composite soft magnetic alloy material, 8.40 parts of an epoxy resin, 2.35 parts of ethylenediamine, and 6 parts of ethyl acetate. The magnetic permeability of the magnetic slurry is tested to be 24.6 at a frequency f of 1 MHz.

The size, inductance performance and DC resistance of pouring power inductors provided in Examples 1-8 are tested, and the results are shown in Table 1.

TABLE 1

| | | Permeability | | |
|---|---|---|---|---|
| | | of magnetic | Inductance | DC resis- |
| | Size/mm | slurry | performance/μH | tance/mΩ |
| Example 1 | 2.5*2.0*1.0 | 32.8 | 2.2 ± 0.3 | 65 ± 6 |
| Example 2 | 2.5*2.0*1.0 | 34.87 | 2.2 ± 0.4 | 65 ± 6 |
| Example 3 | 2.0*1.6*0.8 | 31.2 | 1.0 ± 0.2 | 30 ± 3 |
| Example 4 | 2.0*1.6*0.8 | 28.84 | 1.0 ± 0.2 | 30 ± 3 |
| Example 5 | 1.6*1.2*0.8 | 30.82 | 1.0 ± 0.2 | 40 ± 4 |
| Example 6 | 2.5*2.0*1.0 | 38.45 | 2.6 ± 0.4 | 65 ± 6 |
| Example 7 | 2.0*1.6*0.8 | 34.46 | 1.0 ± 0.2 | 30 ± 3 |
| Example 8 | 1.6*1.2*0.8 | 24.6 | 0.8 ± 0.2 | 40 ± 4 |

In the present application, the pouring power inductor provided in Example 6 has very large eddy current loss, small temperature-rise current and low inductance efficiency; in the pouring power inductor provided in Example 7, the adhesion strength between the pouring body and the combined component is low, resulting in product falling apart; the pouring power inductor provided in Example 8 has low magnetic permeability, which results in an inductance value failing to meet the technical requirements.

In summary, the pouring power inductor provided in the present application realizes pressureless molding by pouring a magnetic slurry to prevent the coil from short circuit, open circuit or a shift to the edge of the inductor due to high pressure; the reliability of the inductor and the yield of the product are effectively improved.

The applicant declares that the above is only specific embodiments of the present application, and the protection scope of the present application is not limited thereto. It should be understood by those skilled in the art that any change or replacement which is obvious to those skilled in the art within the technical scope disclosed by the present application shall fall within the protection scope and disclosure scope of the present application.

1. A pouring power inductor, comprising a T-shaped base, a coil and a pouring body;
the base comprises a lower portion and a center post;
the center post is fixed at the center of the lower portion;
the coil is tightly wound on the center post;
the pouring body is used to enclose the base and the coil.

2. The pouring power inductor according to claim 1, wherein one side of the lower portion is provided with wire grooves.

3. The pouring power inductor according to claim 2, wherein two terminals of the coil are arranged on the bottom of the lower portion through the wire grooves.

4. A method for preparing the pouring power inductor according to claim 1, comprising the following steps:
(1) body preparation: putting a prepared powder into a T-shaped mold with a preset size, performing hot press molding, and then baking the same to obtain a T-shaped base;
(2) coil winding: winding an enameled wire on a center post of the T-shaped base obtained in step (1), and bending and fitting two terminals to the bottom of a lower portion of the T-shaped base to obtain a combined component;
(3) combined component arrangement: arranging and sticking the combined components obtained in step (2) onto a thermosensitive adhesive film in an n×m array at equal spacing;
(4) slurry pouring: installing a pouring mold above the thermosensitive adhesive film, and injecting a magnetic slurry to obtain a second combined component;
(5) curing treatment: subjecting the second combined component obtained in step (4) to curing treatment, demolding and grinding in turn to obtain an inductor body; and
(6) post-treatment: subjecting the inductor body obtained in step (5) to cutting, spray coating and plating in turn to obtain the pouring power inductor.

5. The preparation method according to claim 4, wherein a method for preparing the prepared powder in step (1) comprises:
(1.1) mixing a main powder and an auxiliary powder to obtain a composite soft magnetic alloy powder; and
(1.2) mixing a binder, a curing agent, acetone and the composite soft magnetic alloy powder obtained in step (1.1) with to obtain the prepared powder.

6. The preparation method according to claim 5, wherein the main powder in step (1.1) comprises any one or a combination of at least two of a FeSiAl powder, a FeSi powder or a FeNi powder.

7. The preparation method according to claim 5, wherein the main powder in step (1.1) has a D50 of 20-40 μm.

8. The preparation method according to claim 5, wherein the auxiliary powder in step (1.1) comprises any one or a combination of at least two of a FeSiAl powder, a FeSi powder or a FeNi powder;
preferably, the auxiliary powder in step (1.1) has a D50 of 2-10 μm.

9. The preparation method according to claim 4, wherein the hot press molding in step (1) is performed at 160-240° C.;
preferably, the hot press molding in step (1) is performed at 300-600 MPa;
preferably, the baking in step (1) is performed at 180-260° C.

10. The preparation method according to claim 4, wherein the spacing of the combined components in step (3) is 0.5-2 mm;
preferably, a thermosensitive adhesive in the thermosensitive adhesive film in step (3) has an adhesion of 2000-3000 gf/25 mm.

11. The preparation method according to claim 4, wherein the magnetic slurry in step (4) has a viscosity of 15000-25000 mpa·s;
preferably, raw materials of the magnetic slurry in step (4) comprises (in parts by weight): 100 parts of a composite soft magnetic alloy material, 2-8 parts of an epoxy resin, 0.5-2.5 parts of a curing agent, and 2-6 parts of an organic solvent;
preferably, the curing agent comprises any one or a combination of at least two of ethylenediamine, diethylenetriamine, diethyltoluenediamine or dicyandiamide;
preferably, the organic solvent comprises any one or a combination of at least two of ethyl acetate, n-propanol, isopropanol or ethanol.

12. The preparation method according to claim 11, wherein a method for preparing the magnetic slurry in step (4) comprises:
(4.1) mixing an epoxy resin with an organic solvent and stirring for 1-3 h to obtain an organic mixture;
(4.2) adding a composite soft magnetic alloy material to the organic mixture obtained in step (4.1), and stirring for 4-12 h to obtain a semi-finished soft magnetic alloy powder slurry; and
(4.3) mixing and stirring a curing agent and the semi-finished soft magnetic alloy powder slurry obtained in step (4.2) for 20-40 min, and then performing vacuum degassing to obtain the magnetic slurry;
preferably, the composite soft magnetic alloy material in step (4.2) is a mixture of a first powder, a second powder and a third powder;
preferably, the first powder comprises any one or a combination of at least two of a FeSiAl powder, a FeSi powder, a FeNi powder or an amorphous powder;
preferably, the first powder has a D50 of 100-150 μm;
preferably, the second powder comprises any one or a combination of at least two of a FeSiAl powder, a FeSi powder, a FeNi powder or an amorphous powder;
preferably, the second powder has a D50 of 20-50 μm;
preferably, the third powder comprises any one or a combination of at least two of a FeSiAl powder, a FeSi powder, a FeNi powder or an amorphous powder;
preferably, the third powder has a D50 of 4-10 μm;
preferably, the first powder, the second powder and the third powder have a mass ratio of 6:(1-3):(1-3);
preferably, the amorphous powder comprises FeSiBCr.

13. The preparation method according to claim 4, wherein the pouring mold in step (4) is 0.4-1.5 mm higher than the inductor, preferably 0.6-1.2 mm.

14. The preparation method according to claim 4, wherein the curing in step (5) comprises a first stage curing, a second stage curing and a third stage curing which are performed sequentially;
preferably, the first stage curing is performed at 80-100° C.;
preferably, the first stage curing has a temperature-holding period of 2-4 h;
preferably, the second stage curing is performed at 120-140° C.;
preferably, the second stage curing has a temperature-holding period of 0.5-2 h;
preferably, the third stage curing is performed at 150-200° C.;
preferably, the third stage curing has a temperature-holding period of 1-3 h.

15. The preparation method according to claim 4, comprising the following steps:
(1) body preparation: putting a prepared powder into a T-shaped mold with a preset size, performing hot press molding, and then baking the same at 180-260° C. to obtain a T-shaped base; wherein the hot pressing molding is performed at 160-240° C. with a pressure of 300-600 MPa;
(1.1) mixing a main powder and an auxiliary powder to obtain a composite soft magnetic alloy powder; wherein the main powder has a D50 of 20-40 μm, and the auxiliary powder has a D50 of 2-10 μm;
(1.2) mixing a binder, a curing agent, acetone and the composite soft magnetic alloy powder obtained in step (1.1) to obtain the prepared powder;
(2) coil winding: winding an enameled wire onto a center post of the T-shaped base obtained in step (1), and bending two terminals and fitting the same to the bottom of a lower portion of the T-shaped base to obtain a combined component;
(3) combined component arrangement: arranging and sticking the combined components obtained in step (2) onto a thermosensitive adhesive film which has an adhesion of 2000-3000 gf/25 mm in an n×m array at equal spacing; wherein the spacing of the combined components is 0.5-2 mm;
(4) slurry pouring: installing a pouring mold above the thermosensitive adhesive film, and injecting a magnetic slurry with a viscosity of 15000-25000 mpa·s to obtain a second combined component; wherein the pouring mold is 0.4-1.5 mm higher than the inductor;
(4.1) mixing an epoxy resin with an organic solvent and stirring for 1-3 h to obtain an organic mixture;
(4.2) adding a composite soft magnetic alloy material into the organic mixture obtained in step (4.1), and stirring for 4-12 h to obtain a semi-finished soft magnetic alloy powder slurry; wherein the composite soft magnetic alloy material is a mixture of a first powder, a second powder and a third powder; the first powder has a D50 of 100-150 μm, the second powder has a D50 of 20-50 μm, and the third powder has a D50 of 4-10 μm;
(4.3) mixing and stirring a curing agent and the semi-finished soft magnetic alloy powder slurry obtained in step (4.2) for 20-40 min, and then performing vacuum degassing to obtain the magnetic slurry;
(5) curing treatment: subjecting the second combined component obtained in step (4) to curing treatment, demolding and grinding in turn to obtain an inductor body; wherein the curing treatment comprises a first stage curing, a second stage curing and a third stage curing which are performed sequentially; the first stage curing is performed at 80-100° C. and held for 2-4 h; the second stage curing is performed at 120-140° C. and held for 0.5-2 h; the third stage curing is performed at 150-200° C. and held for 1-3 h; and
(6) post-treatment: subjecting the inductor body obtained in step (5) to cutting, spray coating and plating in turn to obtain the pouring power inductor.
